(19) United States
(12) Patent Application Publication
(10) Pub. No.: US 2024/0076455 A1
(43) Pub. Date: Mar. 7, 2024

(54) METHOD FOR PRODUCING FIBER-REINFORCED POLYBUTYLENE TEREPHTHALATE RESIN COMPOSITION

(71) Applicant: MITSUBISHI ENGINEERING-PLASTICS CORPORATION, Tokyo (JP)

(72) Inventors: Toshiyuki TAJIRI, Hiratsuka-shi (JP); Masaru TAKEHANA, Hiratsuka-shi (JP)

(73) Assignee: Mitsubishi Chemical Corporation, Chiyoda-ku (JP)

(21) Appl. No.: 18/262,683

(22) PCT Filed: Jan. 13, 2022
(86) PCT No.: PCT/JP2022/000874

§ 371 Date: Jul. 24, 2023

(30) Foreign Application Priority Data
Feb. 16, 2021 (JP) 2021-022418

(51) Int. Cl. C08J 3/20; B29B 7/48; B29B 7/90; C08K 7/14; C08L 67/02

(52) U.S. Cl. CPC C08J 3/203; B29B 7/48; B29B 7/90; C08K 7/14; C08L 67/02; B29K 2067/006; C08J 2367/02

(57) ABSTRACT

A method for manufacturing a fiber-reinforced polybutylene terephthalate resin composition contain 40-90 mass % of a polybutylene terephthalate resin, 10-60 mass % of a reinforcing fiber, and 0-35 mass % of other polymer or additive by using a twin-screw extruder, the method includes using polybutylene terephthalate resin pellets (avg. weight of 16-29 mg) as a raw material for the resin by: (1) kneading the resin and the fiber with a first kneading part; (2) adding the fiber at a part downstream of the first kneading part and performing kneading with a second kneading part; and (3) reducing pressure of a vent at a part downstream of the second kneading part and performing devolatilization, where the first kneading part has a length of 5.0-9.0 D and a specific screw configuration, the second kneading part contains a specific screw configuration, and the production is carried out with a screw shaft torque density of 11.5-19 Nm/cm³.

### TECHNICAL FIELD

The present invention relates to a method for producing a fiber-reinforced polybutylene terephthalate resin composition, and more specifically relates to a method for producing a fiber-reinforced polybutylene terephthalate resin composition having higher strength than the prior art and produced at high productivity by using a high-torque twin screw extruder.

### BACKGROUND ART

Polybutylene terephthalate resin are widely used in a variety of electrical and electronic components, mechanical components and automotive components, mainly for injection molding. In particular, fiber-reinforced polybutylene terephthalate resin compositions, in which reinforcing fibers such as glass fibers and carbon fibers are blended, exhibit excellent mechanical strength, heat resistance, chemical resistance, and so on, and are used as components in the automotive field, the field of electrical and electronic devices, and so on.

However, as components have become smaller, thinner and lighter recently, there have been strong demands for fiber-reinforced polybutylene terephthalate resin compositions to exhibit even higher mechanical strength.

Fiber-reinforced polybutylene terephthalate resin compositions are generally produced using twin screw extruders. For many years, attempts have been made to improve the plasticizing and kneading capabilities of twin screw extruders in order to improve production capacity. Recently, ultra-high torque extruders having allowable shaft torque densities of close to 18 Nm/cm³ have been developed (for example, “TEXαIII” produced by Japan Steel Works, Ltd.), and this has enabled production in a previously impossible high torque range, thereby enabling higher discharge rates than in the past.

However, it has become clear that if this type of ultra-high torque extruder is used, problems can occur, such as resin residence times becoming shorter, the resin temperature becoming unlikely to rise, adhesion to reinforcing fibers such as glass fibers decreasing, and mechanical strength decreasing.

PTL 1 discloses an invention in which a backward feeding screw element having a flight part, in which a circular notch is formed, is used in order to increase the productivity of a glass fiber-reinforced thermoplastic resin composition pellet beyond what was possible in the past and significantly reduce the likelihood of monofilament aggregates (unfibrillated glass-fiber bundles) remaining in produced pellets. Conditions in this case are specified such that (i) the torque density, which is a value obtained by dividing the torque of the screw in the backward feeding screw element by the cube of the center-to-center distance between engaging screws, is 11 Nm/cm³ or more, and (ii) the Q/Ns density is 0.013 kg/h/rpm/cm³, which is a value obtained by dividing Q/Ns, which is the discharge rate Q divided by the screw rotation speed Ns, by the cube of the center-to-center distance between screws.

With regard to torque density, however, PTL 1 (paragraph) only indicates that “if the torque density is 11 (Nm/cm³) or more, the filling rate of a material in the extruder increases, energy density decreases, and there is little temperature increase even if the speed of rotation is higher than in the past. In addition, a preferred torque density range is from 13 (Nm/cm³) to 18 (Nm/cm³)”, and the working examples do not disclose the level of torque density in any way, and do not disclose how to achieve such a torque density. “A TEX44αII (produced by Japan Steel Works, Ltd.) having a screw element cylinder diameter D of 0.047 m” is used as a twin screw extruder in the working examples in PTL 1, but the TEX44αII has an allowable shaft torque density of 13 Nm/cm³, and because a screw shaft or gear box would be damaged at a shaft torque density greater than this, the torque density is 10.5 Nm/cm³ at most because the apparatus is generally operated at 80% or less of the allowable shaft torque density.

In addition, ultra-high torque density twin screw extruders such as that mentioned above had not yet appeared anywhere in the world when PTL 1 was filed. Therefore, what PTL 1 specifically discloses are conditions for a conventional low torque extruder, and does not disclose or suggest problems that occur during ultra-high torque operations covered by the present invention, and moreover does not provide means for solving these problems.

### CITATION LIST

### Patent Literature

[PTL 1] JP 2012-213997 A

### SUMMARY OF INVENTION

### Technical Problem

In a case where a fiber-reinforced polybutylene terephthalate resin composition is produced at a high torque density using an ultra-high torque extruder, because the residence time is shorter, it was found that problems occurred, such as the resin temperature being unlikely to rise, meaning that adhesion to reinforcing fibers is insufficient and the strength of an obtained resin composition does not increase. Lowering the discharge rate and increasing the kneading time was considered in order to increase the resin temperature, but because the production quantity decreases, there is no reason to use an ultra-high torque extruder.

In view of problems such as those mentioned above, the object of the present invention is to produce a fiber-reinforced polybutylene terephthalate resin (pellet) having higher strength than in the past and produced at high productivity by using an ultra-high torque extruder.

### Solution to Problem

As a result of diligent research carried out in order to solve the problems mentioned above, the inventors of the present invention have found that by carrying out production in a high torque region using polybutylene terephthalate resin pellets having an average weight within a specific range as a raw material, with use of a first kneading part having a specific screw configuration and screw length and a second kneading part having a specific screw configuration, with a screw shaft torque density being 11.5 to 19 Nm/cm³, the resin temperature can be maintained at a temperature above a certain temperature, adhesion between the polybutylene terephthalate resin and reinforcing fibers is increased, an improvement in strength due to the reinforcing fibers is further enhanced, a decrease in the fiber length of fibrillated and dispersed reinforcing fibers is suppressed, resin degradation does not occur, production can be carried out with high productivity, and a fiber-reinforced polybutylene terephthalate resin having high strength can be produced.

Specifically, the problems mentioned above can be solved using the method described below.

1. A method for producing a fiber-reinforced polybutylene terephthalate resin composition comprising (A) 40 to 90 mass % of a polybutylene terephthalate resin, (B) 10 to 60 mass % of reinforcing fibers, and (C) 0 to 35 mass % of other polymers or additives (the total amount of each component is 100 mass %), by using a twin-screw extruder,
the method comprises:
using polybutylene terephthalate resin pellets having an average weight of 16 mg or more and 29 mg or less as a raw material for component (A),
a first step of kneading components (A) and (C) with a first kneading part, a second step of adding component (B) at a part downstream of the first kneading part and performing kneading with a second kneading part, and a third step of reducing a pressure of a vent at a part downstream of the second kneading part and performing devolatilization, wherein
the first kneading part has a configuration in which a length thereof is 5.0 D to 9.0 D (D is a cylinder diameter) and which is obtained by combining two or more of an R kneading disc, an N kneading disc, an L kneading disc, an L screw, a sealing ring, a mixing screw and a rotor screw, and
the second kneading part has a configuration which is obtained by combining one or more of an R kneading disc, an N kneading disc, an L kneading disc, an L screw, a sealing ring and a mixing screw, and
production is carried out under the conditions of a screw shaft torque density of 11.5 to 19 Nm/cm³.

2. The production method of 1 above, wherein component (C) comprises a styrenic polymer at a quantity of 5 to 30 mass % relative to the total of 100 mass % of components (A) to (C).

3. The production method of 1 or 2 above, wherein a temperature of a resin strand is 290 to 310° C. immediately after being extruded in the third step.

4. The production method of any one of 1 to 3 above, wherein an intrinsic viscosity of the polybutylene terephthalate resin (A) is 0.72 to 0.83 dl/g.

5. The production method of any one of 1 to 4 above, wherein a total length of the second kneading part is 2.5 D or more and 5.0 D or less.

6. The production method of any one of 1 to 5 above, wherein a notched Charpy impact strength of the obtained resin composition, as measured in accordance with ISO179-1,2, is 9 kJ/m² or more.

7. The production method of any one of 1 to 6 above, wherein a tensile strength of the obtained resin composition, as measured in accordance with 1S0527, is 140 MPa or more.

8. The production method of any one of 1 to 7 above, wherein the screw shaft torque density is 13 to 19 Nm/cm³.

### Advantageous Effects of Invention

According to the method for producing a fiber-reinforced polybutylene terephthalate resin composition of the present invention, it is possible to increase adhesion between a polybutylene terephthalate resin and reinforcing fibers even if production is carried out in a high torque range, at a high discharge rate and with a short residence time, a strength improvement effect achieved by the reinforcing fibers is extremely high, higher strength is achieved because resin degradation does not occur, and a fiber-reinforced polybutylene terephthalate resin composition can be produced with high productivity. In addition, it is possible to produce, with extremely high productivity, a high strength resin composition that could not be achieved in the past in operations carried out in a high torque range, such as an obtained polybutylene terephthalate resin composition having a Charpy impact strength of 9 kJ/m² or more and a tensile strength of 140 MPa or more.

### BRIEF DESCRIPTION OF DRAWINGS

FIG. 1

This is a conceptual diagram for explaining an example of a screw configuration of an extruder used in working examples and comparative examples.

### DESCRIPTION OF EMBODIMENTS

The present invention will now be explained in detail through the use of embodiments and examples, but the present invention is not limited to the embodiments and examples shown below, and may be arbitrarily altered as long as there is no deviation from the gist of the present invention. Moreover, use of the symbol “-” in the present specification means that numerical values mentioned before and after the “-” include the lower limit and upper limit thereof.

The method for producing a fiber-reinforced polybutylene terephthalate resin composition of the present invention is a method for producing a fiber-reinforced polybutylene terephthalate resin composition comprising (A) 40 to 90 mass % of a polybutylene terephthalate resin, (B) 10 to 60 mass % of reinforcing fibers, and (C) 0 to 35 mass % of other polymers or additives (the total amount of each component is 100 mass %), by using a twin-screw extruder,
the method comprises:
using polybutylene terephthalate resin pellets having an average weight of 16 mg or more and 29 mg or less as a raw material for component (A),
a first step of kneading components (A) and (C) with a first kneading part, a second step of adding component (B) at a part downstream of the first kneading part and performing kneading with a second kneading part, and a third step of reducing a pressure of a vent at a part downstream of the second kneading part and performing devolatilization, wherein
the first kneading part has a configuration in which a length thereof is 5.0 D to 9.0 D (D is a cylinder diameter) and which is obtained by combining two or more of an R kneading disc, an N kneading disc, an L kneading disc, an L screw, a sealing ring, a mixing screw and a rotor screw, and
the second kneading part has a configuration which is obtained by combining one or more of an R kneading disc, an N kneading disc, an L kneading disc, an L screw, a sealing ring and a mixing screw, and
production is carried out under the conditions of a screw shaft torque density of 11.5 to 19 Nm/cm³.

The extruder used in the present invention is a vented twin screw extruder, and is preferably an engagement type co-rotating twin screw extruder which has two screws that rotate in the same direction in the inner part of a barrel, where kneading parts constituted from a plurality of kneading discs are provided so as to engage with each other in the midst of the screws.

The vented twin screw extruder is constituted from: a cylinder provided with a raw material supply port, a vent port and a jacket; and a die part attached to the tip of the extruder, and has a supply port for supplying (A) pellets of a raw material polybutylene terephthalate resin and (C) other polymers or additives, a first kneading part, a supply port for side-feeding (B) reinforcing fibers, a second kneading part, and a vent part. The resin composition is produced using a process that includes a first step of kneading components (A) and (C) with a first kneading part, a second step of adding component (B) at a part downstream of the first kneading part and performing kneading with a second kneading part, and a third step of reducing the pressure of a vent at a part downstream of the second kneading part and performing devolatilization.

In the first step, components (A) and (C) are supplied to the extruder from the raw material supply port and are melted by being heated and kneaded by the screws. The first kneading part, which is constituted from a plurality of kneading discs, is formed in the midst of the screws. The first kneading part kneads the polybutylene terephthalate resin pellets and other polymers or additives after these are introduced, and is a kneading part positioned before the reinforcing fibers are introduced. This screw configuration has a length of 5.0 D to 9.0 D (D is the cylinder diameter) and is obtained by combining two or more of an R kneading disc, an N kneading disc, an L kneading disc, an L screw, a sealing ring, a mixing screw and a rotor screw. The first kneading part kneads the polybutylene terephthalate resin pellets, which have an average weight of 16 to 29 mg, and other polymers or additives after these are introduced, and is a kneading part positioned before the reinforcing fibers are introduced.

The first kneading part may be combined into a single section or divided into a plurality of sections. That is, the first kneading part may be divided into multiple sections and a forward feeding screw may be inserted between these sections. It is important that the total length of the kneading part is 5.0 D to 9.0 D.

The R kneading disc (hereinafter also referred to as R) is a forward feeding kneading disc element, and generally has two or more vanes, with the angle of twist 0 between the vanes preferably being 10° to 75°. By offsetting the vanes by a prescribed angle in this way, a pseudo-screw structure is formed, the resin is transported in a forward direction, a strong shearing force is applied, and a kneading zone is formed.

The L kneading disc (hereinafter also referred to as L) is a backward feeding kneading disc element, and generally has two or more vanes, and preferably has the angle of twist e between the vanes preferably being −10° to −75°. The backward feeding kneading disc element has a pressure-increasing function that dams up the transported resin and acts on the transported resin in a backwards direction, and by providing this backward feeding kneading disc element downstream of an element that facilitates kneading, the resin is dammed up and a strong kneading effect is exhibited.

The N kneading disc (hereinafter also referred to as N) is an orthogonal kneading disc element, and generally has two or more vanes, and has the angle of twist e between the vanes being 75° to 105°. Because the vanes are disposed so as to be offset by approximately 90°, the force for transporting the resin is weak, but the kneading force is strong.

The L screw is a backward feeding screw, the sealing ring limits flow of the resin in an upstream part by means of gaps in the sealing ring part, the mixing screw is a screw element having a notch in the peak (flight part) of the screw, and the rotary screw is a screw element having one or more lines on the outer circumferential surface thereof.

Of these, the R kneading disc, N kneading disc and L kneading disc are preferred, and a configuration in which a plurality of these are combined is preferred.

The screw configuration of the first kneading part in the first step is formed by combining two or more of the elements mentioned above, but it is preferable for an element that facilitates kneading to be disposed on the upstream side and an element having a pressure-increasing function to be disposed on the downstream side. Therefore, in the first kneading part, it is preferable to dispose two or more selected from among R, N and L in the order R→N→L from the upstream side, and it is also preferable to dispose a plurality of each of R, N and L. It is particularly preferable to dispose R on the upstream side then a plurality of N, and then L.

The screw length in the first kneading part is 5.0 D to 9.0 D, where D denotes the cylinder diameter. If the screw length falls within such a range, the polybutylene terephthalate resin is sufficiently melted and plasticized, and decomposition of the resin composition can be suppressed. If the screw length of the first kneading part is less than 5.0 D, melting and plasticizing are insufficient because shearing is insufficient, and if this screw length exceeds 9.0 D, local decomposition of the resin composition tends to progress due to excessive kneading, and mechanical properties of the composition deteriorate.

After kneading and melting the polybutylene terephthalate resin in the first step, it is preferable to carry out venting using the vent. It is preferable to provide a sealing ring downstream of the vent.

In the second step, reinforcing fibers are side-fed from a supply port positioned downstream of the first kneading part after the first step described above, and the reinforcing fibers and the molten polybutylene terephthalate resin are kneaded by the second kneading part. The second kneading part is a kneading part in which the reinforcing fibers are introduced, opened and kneaded. The screw configuration of the second kneading part is formed by combining one or more of an R kneading disc, an N kneading disc, an L kneading disc, an L screw, a sealing ring and a mixing screw. If kneading is carried out in a state that is not configured from these, opening and dispersion of the reinforcing fibers tends to be insufficient. Of the elements mentioned above, a configuration having at least a mixing screw, and especially a forward feeding notched mixing screw and a backward feeding notched mixing screw, is preferred.

The screw length in the second kneading part is preferably 2.5 D to 5.0 D. The second kneading part may be combined into a single section or divided into multiple sections. That is, the second kneading part may be divided into multiple sections and a forward feeding screw may be inserted between these sections. In any configuration, the total length of the kneading part is preferably 2.5 D to 5.0 D. By setting the screw length in the second kneading part to fall within such a range, opening and dispersion of the reinforcing fibers is good and the strength of the resin composition tends to improve.

Operation is carried out using a high torque twin screw extruder at a screw shaft torque density of 11.5 to 19 Nm/cm³.

Screw shaft torque density is defined as a value obtained by dividing the required torque (Nm) for operating one screw by the cube of the distance between screw shaft centers, and has units of Nm/cm³. Even if extrusion is carried out using an extruder having a different size, the torque applied to the resin per unit volume is the same if this torque density value is the same. A motor that drives a screw generates a torque (Nm), which is transmitted to the screw shaft, which does the work of transporting and melting the polybutylene terephthalate resin and transporting and opening the reinforcing fibers. In the present invention, this torque density indicates the strength of the torque applied to the base of the screw shaft. The torque density decreases in value towards the tip, and is almost 0 at the tip of the screw.

The torque generated by the motor that drives the screws of the extruder is displayed on a control panel in terms of percentage relative to 100% of the screw allowable torque. For example, in the case of a TEX44αIII, a torque value of 100% corresponds to a torque density of 17.6 Nm/cm³, and torque density can be calculated from the displayed percentage at the time of operation. In addition, in the case of ordinary VVVF inverter control, a value obtained by dividing the current (A) in a fixed torque region by the rated current matches the torque percentage.

The screw shaft torque density is 11.5 to 19 Nm/cm³, but is preferably 12.0 Nm/cm³ or more, more preferably 12.5 Nm/cm³ or more, and further preferably 13 Nm/cm³ or more, and is preferably 18 Nm/cm³ or less, and more preferably 17 Nm/cm³ or less. By setting the screw shaft torque density to fall within such a range, a high strength fiber-reinforced polybutylene terephthalate resin composition can be stably produced at a high discharge rate.

In order for the screw shaft torque density to fall within such a range, the screw shaft torque density can be adjusted by controlling the feed rate of raw materials so as to achieve this torque range.

In the present invention, polybutylene terephthalate resin pellets having an average weight of 16 to 29 mg are used as a raw material polybutylene terephthalate resin under the torque density conditions described above. By supplying pellets having this type of average weight to the extruder, the resin temperature can be easily controlled within a suitable range. If this average weight is too low, the resin temperature tends to rise to a higher temperature than required, and if this average weight is too high, it is difficult to increase the resin temperature.

The average weight is preferably 18 mg or more, more preferably 19 mg or more, and further preferably 20 mg or more, and is preferably 27 mg or less, more preferably 25 mg or less, and further preferably 24 mg or less.

The average weight of the polybutylene terephthalate resin pellets is the number average weight of the pellets and, more specifically, is an average value (mg/pellet) calculated from 100 arbitrary pellets. For example, fragmented products, powders and granular products that are not in the form of pellets, such as those produced during production, transportation or handling, are not counted.

The resin temperature in the second step is preferably 280 to 320° C., and especially 290 to 310° C. The resin temperature can be adjusted by adjusting the discharge rate or screw rotation speed of the extruder as appropriate, or by using a method for adjusting the screw configuration in the first step or a method for setting a low preset cylinder temperature in the second step.

The screw rotation speed of the twin screw extruder is preferably 300 to 800 rpm, and more preferably 400 to 700 rpm. In addition, the discharge rate in the case of a TEX44αIII is preferably 450 to 650 kg/h, and more preferably 480 to 630 kg/h. In the case of an extruder having a different size, the discharge rate is preferably in a range proportional to the 2.5th power of the cylinder diameter ratio.

Following the second step, depressurization and devolatilization are carried out using the downstream vent part in a third step, but the degree of vacuum during this process is preferably −0.097 MPa to −0.07 MPa. Here, degree of vacuum means gauge pressure.

Next, the polybutylene terephthalate resin composition is extruded in the form of a strand from an extruding die at the tip of the extruder (an extrusion step). The temperature of the extruded resin composition strand is preferably 290 to 310° C., and especially 295 to 310° C.

The shape of the extruding die is not particularly limited, and a well-known type of die is used. The diameter of the die hole depends on the desired pellet dimensions, but is generally 2 to 5 mm, and preferably approximately 3 to 4 mm.

The strand is then taken up by a take-up roller and cooled through contact with water.

The contact with water is such that the strand may be cooled by being transported through water held in a cooling water tank, or the strand may be cooled by applying water to the strand so as to effect contact with water, or it is possible to use a method comprising drawing the strand on a mesh belt conveyor and applying water to the strand using a water discharging device. The period of time between extruding the strand from the die and water-cooling the strand or placing the strand in water is preferably shorter. In general, the strand should be placed in water preferably within one second of being extruded from the die.

The cooled strand is then transported to a pelletizer by means of the take-up roller, and cut to form pellets.

According to the method of the present invention, a high strength polybutylene terephthalate resin composition that could not be achieved in the past in operations carried out in a high torque range can be produced with extremely high productivity. The obtained polybutylene terephthalate resin composition (pellet) has extremely high strength. Specifically, the notched Charpy impact strength is preferably 9 kJ/m² or more, more preferably 9.5 kJ/m² or more, and within this, is 10 kJ/m² or more, and especially 10.5 kJ/m² or more, and the tensile strength is preferably 140 MPa or more, and more preferably 145 MPa or more, and within this, is 150 MPa or more, and especially 155 MPa or more.

Here, the notched Charpy impact strength is measured in accordance with 1S0179-1,2, and the tensile strength is measured in accordance with ISO527. Specific details of these measurement methods are as described in the working examples section.

An explanation will now be given of raw material components used in the present invention.

The polybutylene terephthalate resin (A) is a polyester resin having a structure in which terephthalic acid units and 1,4-butane diol units are bonded by ester bonds, and includes, in addition to polybutylene terephthalate resin (homopolymer), polybutylene terephthalate copolymer that contain other copolymer components in addition to terephthalic acid unit and 1,4-butane diol unit, and mixtures of homopolymer and such copolymer.

The polybutylene terephthalate resin may contain dicarboxylic acid units other than terephthalic acid, and specific examples of these other dicarboxylic acid units include aromatic dicarboxylic acids such as isophthalic acid, orthophthalic acid, 1,5-naphthalenedicarboxylic acid, 2,5-naphthalenedicarboxylic acid, 2,6-naphthalenedicarboxylic acid, biphenyl-2,2′-dicarboxylic acid, biphenyl-3,3′-dicarboxylic acid, biphenyl-4,4′-dicarboxylic acid, bis(4,4′-carboxyphenyl)methane, anthracenedicarboxylic acid and 4,4′-diphenyl ether dicarboxylic acid; alicyclic dicarboxylic acids such as 1,4-cyclohexanedicarboxylic acid and 4,4′-dicyclohexyldicarboxylic acid; and aliphatic dicarboxylic acids such as adipic acid, sebacic acid, azelaic acid and dimer acids.

In cases where the polybutylene terephthalate resin (A) contains diol units other than 1,4-butane diol, specific examples of these other diol units include aliphatic and alicyclic diols having 2 to 20 carbon atoms and bisphenol derivatives. Specific examples thereof include ethylene glycol, propylene glycol, 1,5-pentane diol, 1,6-hexane diol, neopentyl glycol, decamethylene glycol, cyclohexane dimethanol, 4,4′-dicyclohexylhydroxymethane, 4,4′-dicyclohexylhydroxypropane and ethylene oxide-added diols of bisphenol A. In addition to difunctional monomers such as those mentioned above, it is possible to additionally use a small quantity of a trifunctional monomer, such as trimellitic acid, trimesic acid, pyromellitic acid, pentaerythritol or trimethylolpropane in order to introduce a branched structure, or a monofunctional compound such as a fatty acid in order to adjust molecular weight.

The polybutylene terephthalate resin is preferably a polybutylene terephthalate homopolymer obtained through polycondensation of terephthalic acid and 1,4-butane diol, but may also be a polybutylene terephthalate copolymer containing one or more dicarboxylic acids other than terephthalic acid as carboxylic acid units and/or one or more diols other than 1,4-butane diol as diol units as long as the crystallinity of the polybutylene terephthalate resin is not impaired, and in cases where the polybutylene terephthalate resin is a polybutylene terephthalate resin modified by means of copolymerization, examples of preferred specific copolymers include polyester-ether resin obtained by copolymerizing with polyalkylene glycols, and especially polytetramethylene glycol, dimer acid-copolymerized polybutylene terephthalate resin and isophthalic acid-copolymerized polybutylene terephthalate resin.

Moreover, in these copolymers, the copolymerization amount is not less than 1 mol % and less than 50 mol % of all segments in the polybutylene terephthalate resin. Within this range, the copolymerization amount is preferably not less than 2 mol % and less than 50 mol %, more preferably 3 to 40 mol %, and particularly preferably 5 to 20 mol %. Such a copolymerization proportion is preferred from the perspectives of improving fluidity and ductility.

The intrinsic viscosity IV of the polybutylene terephthalate resin is preferably 0.72 to 0.83 dl/g. It was found that by having this type of low intrinsic viscosity, the resin temperature can be easily controlled to a temperature at which adhesive strength to the reinforcing fibers is high and a decrease in strength caused by resin degradation is unlikely to occur, such as a resin temperature of 290 to 310° C. at a high torque density. If the intrinsic viscosity is less than 0.72 dl/g, adhesion to the reinforcing fibers tends to be insufficient, and if the intrinsic viscosity exceeds 0.83 dl/g, heat generation tends to occur, resin degradation occurs, and strength tends to decrease. The intrinsic viscosity is more preferably 0.73 dl/g or more, and is more preferably 0.82 dl/g or less.

In the present invention, the intrinsic viscosity of the polybutylene terephthalate resin is a value measured using an Ubbelohde type viscometer at a temperature of 30° C. and a Huggins constant of 0.33 in a mixed solvent comprising tetrachloroethane and phenol at a mass ratio of 1:1. Moreover, it is preferable to carry out measurements after removing glass fibers by means of filtration.

The reinforcing fibers (B) may be organic reinforcing fibers or inorganic reinforcing fibers, but inorganic reinforcing fibers are preferred, with glass fibers, carbon fibers, alumina fibers, boron fibers, ceramic fibers, or the like, being preferred, glass fibers or carbon fibers being more preferred, and glass fibers being particularly preferred.

The type of glass fibers is not particularly limited, and examples thereof include glass fibers such as E-glass, C-glass, A-glass and S-glass. Of these, E-glass fibers are preferred from the perspective of not having an adverse effect on the thermal stability of the polybutylene terephthalate resin.

The average fiber diameter of the glass fibers is not particularly limited, but is preferably selected within the range 1 to 100 μm, and is more preferably 2 to 50 μm, further preferably 3 to 30 μm, and particularly preferably 5 to 20 μm. Glass fibers having an average fiber diameter of less than 1 μm are not easy to produce and lead to concerns regarding increased cost, whereas glass fibers having an average fiber diameter of more than 100 μm lead to concerns that the tensile strength of the glass fibers will decrease. Moreover, the fiber cross section may be circular or flat.

The glass fibers may have a fiber cross section that is completely circular or flat, but substantially circular glass fibers in which the fiber cross section has an ellipticity (long axis/short axis) of 1 to 1.5 are preferred. This ellipticity is preferably 1 to 1.4, more preferably 1 to 1.2, and particularly preferably 1 to 1.1.

The average fiber length of the raw material glass fibers is not particularly limited, but is preferably 1 to 10 mm, more preferably 1.5 to 6 mm, and most preferably 2 to 5 mm. If the average fiber length of the raw material glass fibers is less than 1 mm, there are concerns that a reinforcing effect will not be sufficiently exhibited, and if this average fiber length exceeds 10 mm, there are concerns that molding of the obtained resin composition may be difficult.

The glass fibers used can be surface treated with a silane coupling agent such as an aminosilane or an epoxysilane from the perspective of improving adhesion to the polybutylene terephthalate resin.

Examples of coupling agents include chlorosilane compounds such as vinyltrichlorosilane and methylvinyldichlorosilane, alkoxysilane compounds such as vinyltrimethoxysilane, vinyltriethoxysilane, vinyltriacetoxysilane and γ-methacryloxypropyltrimethoxysilane, epoxysilane compounds such as β-(3,4-epoxycyclohexyl)ethyltrimethoxysilane and γ-glycidoxypropyltrimethoxysilane, acrylic compounds, isocyanate compounds, titanate compounds and epoxy compounds.

In addition, the raw material glass fibers are, in general, preferably used as chopped strands (chopped glass fibers) obtained by bundling these fibers into many bundles and then cutting to a prescribed length, and on such occasion, it is preferable to blend a sizing agent with the glass fibers.

A sizing agent for the glass fibers is not particularly limited, and examples thereof include resin emulsions of vinyl acetate resin, ethylene-vinyl acetate copolymer, acrylic resin, epoxy resin, polyurethane resin, polyester resin, and the like, with acrylic resin, epoxy resin and polyurethane resin being preferred.

The amount of reinforcing fibers is 10 to 60 mass % relative to a total of 100 mass % of the polybutylene terephthalate resin (A), the reinforcing fibers (B) and the other polymers or additives (C). If this amount falls within such a range, the strength of the resin composition is high and it is possible to obtain a resin composition having excellent external appearance and fluidity when molded. If this content is less than 10 mass %, the reinforcing effect is insufficient, and if this content exceeds 60 mass %, external appearance and impact resistance deteriorate, and the fluidity of the resin composition tends to be insufficient.

The other polymers or additives (C) are polymers other than the polybutylene terephthalate resin and/or a variety of additives.

Examples of additives include a variety of resin additives, including flame retardants, auxiliary flame retardants, stabilizers, antioxidants, mold-release agents, ultraviolet radiation absorbers, weathering stabilizers, lubricants, coloring agents such as dyes and pigments, catalyst deactivators, anti-static agents, foaming agents, plasticizers, crystal nucleating agents and crystallization accelerators.

Examples of other resins include polyethylene terephthalate resin and polytrimethylene terephthalate resin; polycarbonate resin; polyolefin resin such as polyethylene resin and polypropylene resin; polyamide resin; polyimide resin; polyetherimide resin; polyphenylene ether resin; polyphenylene sulfide resin; polysulfone resin; and polymethacrylate resin.

Moreover, it is possible to incorporate one of these other resins or an arbitrary combination of two or more types thereof combined at arbitrary proportions.

The added quantity of the other polymers or additives (C) is preferably 0 to 35 mass %, and preferably 5 to 30 mass % relative to a total of 100 mass % of components (A) to (C).

Blending an amorphous resin with polybutylene terephthalate resin is known as a means for suppressing molecular orientation caused by crystallization of polybutylene terephthalate, and blending polycarbonate resin or styrenic resin as an amorphous resin is a feature that is often carried out. However, resin compositions containing styrenic resin in particular have a lower viscosity than polybutylene terephthalate resin in isolation, and problems occur, such as opening of reinforcing fiber being difficult, dispersion defects readily occurring, adhesion to reinforcing fiber being poor because it is difficult to increase the resin temperature, and the resin composition not exhibiting strength.

One method for solving these problems is to lower the discharge rate and lengthen the kneading time, but production quantity decreases in such a case. In addition, by using a method comprising increasing the resin temperature, opening of the reinforcing fibers is not sufficient because the viscosity of the styrenic polymer is low, but the method of the present invention is particularly effective as a means for solving these problems because a high strength fiber-reinforced resin composition can be produced with good productivity.

The styrenic polymer preferably has a melt viscosity of 70 to 1000 Pa·s, particularly 70 to 500 Pa·s at 250° C. and 912 sec−1. By blending a styrenic polymer having this type of melt viscosity (η_{B}), a high strength fiber-reinforced polybutylene terephthalate resin composition having a low mold shrinkage factor can be produced with high productivity and excellent production stability. Polystyrene polymers have the effect of lowering viscosity in a high shear region, and have the effect of allowing a resin to readily impregnate into a reinforcing fiber bundle in the second kneading part (fiber opening part) of the extruder. Therefore, adhesive strength between the fiber surface and the resin can be enhanced.

The melt viscosity can be measured in accordance with ISO 11443 using a capillary rheometer and a slit die rheometer. More specifically, melt viscosity can be calculated from the stress when a piston is pushed at a piston speed of 75 ram/min into a furnace body having an internal diameter of 9.5 mm and heated to a temperature of 250° C. using an orifice having a capillary diameter of 1 mm and a capillary length of 30 mm.

Examples of styrenic polymer include styrene homopolymer, graft copolymer obtained by polymerizing styrene in the presence of a rubber, copolymer of styrene and (meth)acrylonitrile, copolymer of styrene and alkyl (meth)acrylate ester, copolymer of styrene, (meth)acrylonitrile and other copolymerizable monomer, and graft copolymer obtained by graft polymerizing styrene and (meth)acrylonitrile in the presence of a rubber. Specific examples include: resins such as polystyrene (general-purpose polystyrene; GPPS), impact-resistant polystyrene (high impact polystyrene; HIPS), acrylonitrile-styrene copolymer (AS resin), acrylonitrile-butadiene-styrene copolymer (ABS resin), styrene-butadiene-styrene copolymer (SBS resin), hydrogenated styrene-butadiene-styrene copolymer (hydrogenated SBS resin), hydrogenated styrene-isoprene-styrene copolymer (SEPS), styrene-maleic anhydride copolymer (SMA resin), acrylonitrile-styrene-acrylic rubber copolymer (ASA resin), methyl methacrylate-butadiene-styrene copolymer (MBS resin), methyl methacrylate-acrylonitrile-butadiene-styrene copolymer (MABS resin), acrylonitrile-acrylic rubber-styrene copolymer (AAS resin), acrylonitrile-ethylene-propylene rubber-styrene copolymer (AES resin) and styrene-IPN rubber copolymer; and mixtures of these.

Of these, acrylonitrile-styrene copolymer (AS resin), polystyrene (GPPS), impact-resistant polystyrene (HIPS) and acrylonitrile-butadiene-styrene copolymer (ABS resin) are preferred, and acrylonitrile-styrene copolymer (AS resin), polystyrene (GPPS), impact-resistant polystyrene (HIPS) and acrylonitrile-butadiene-styrene copolymer (ABS resin) are particularly preferred.

A styrenic elastomer can be used as the styrenic polymer.

Block copolymers comprising a polymer block containing a vinyl aromatic compound as a polymerization component and a polymer block containing a conjugated diene as a polymerization component, and hydrogenated products thereof are preferred as the styrenic elastomer.

Examples of vinyl aromatic compounds that constitute a vinyl aromatic hydrocarbon polymer block include styrene compounds such as styrene, α-methylstyrene, o-methylstyrene, p-methylstyrene, p-t-butylstyrene, 1,3-dimethylstyrene, lower alkyl-substituted styrene compounds, vinylnaphthalene and vinylanthracene, and derivatives thereof. It is possible to use one of these compounds in isolation, or a combination of two or more types thereof.

Examples of conjugated dienes that constitute the conjugated diene block include butadiene, isoprene, 1,3-pentadiene and 2,3-dimethyl-1,3-butadiene.

It is possible to use one styrenic polymer in isolation or a mixture of two or more types thereof.

The amount of the styrenic polymer is preferably 5 to 30 mass % relative to a total of 100 mass % of components (A) to (C).

A polybutylene terephthalate resin composition produced using the method of the present invention can yield a molded article having extremely high strength, and can therefore adequately achieve the required performance in terms of reduced weight, reduced thickness and strength, and can be widely used in molded articles and components in a wide variety of industrial fields, such as electrical/electronic equipment, OA equipment such as computers, precision instruments, optical equipment, motor vehicles and other fields.

### WORKING EXAMPLES

The present invention will now be explained in greater detail through the use of working examples. However, the present invention is not limited to the working examples given below and may be arbitrarily altered as long as the gist of the present invention is not exceeded.

Polybutylene terephthalate resin pellets, reinforcing fibers and other resins used in the working examples and comparative examples are as shown in Table 1 below.

TABLE 1

| Compo- | | |
|---|---|---|
| nent | Abbr. | |
| PBT | PBT1A | Polybutylene terephthalate resin |
| resin | | Novaduran ® 5008 from Mitsubishi Engineering- |
| | | Plastics Corporation |
| | | Pellets having intrinsic viscosity 0.85 dl/g and |
| | | average weight of 22 mg |
| | PBT1B | The same polybutylene terephthalate resin as above |
| | | Pellets having average weight of 14 mg |
| | PBT1C | The same polybutylene terephthalate resin as above |
| | | Pellets having an average weight of 31 mg |
| PBT | PBT2A | Polybutylene terephthalate resin |
| resin | | Novaduran ® 5007 from Mitsubishi Engineering- |
| | | Plastics Corporation |
| | | Pellets having intrinsic viscosity 0.70 dl/g and |
| | | average weight of 22 mg |
| | PBT2B | The same polybutylene terephthalate resin as above |
| | | Pellets having an average weight of 14 mg |
| | PBT2C | The same polybutylene terephthalate resin as above |
| | | Pellets having average weight of 31 mg |
| Rein- | B | Glass fibers (T-187 from Nippon Electric Glass |
| forcing | | Co., Ltd.) |
| fiber | | Average fiber diameter: 13.5 μm, average fiber |
| | | length: 3 mm |
| Other | C | Acrylonitrile-styrene resin (AS resin) |
| polymer | | Denka As GR-AT-R from Denka |
| | | Melt viscosity: approximately 300 pa · s at 250° C. |
| | | and 912 sec⁻¹ |

[Extruder]

The extruder used was a vented engagement type co-rotating twin screw extruder (TEXαIII produced by Japan Steel Works, Ltd.; cylinder diameter D=47 mm).

Screw configurations used in the working examples and comparative examples were such that the first kneading part comprised screws 1 to 4 below and the second kneading part comprised screws 1 to 3 below.

First Kneading Part
Screw 1: RNNNNL; length 5.62 D
Screw 2: RNNNNNNL; length 7.48 D
Screw 3: RNNNNNNNNL; length 9.36 D
Screw 4: RNNNL; length 4.68 D

The kneading discs mentioned above were double flight discs, and the length was 44 mm.

Second Kneading Part
Screw 1: Backward feeding mixing screw length 44 mm (four screws) Total length: 176 mm (3.74 D)
Screw 2: Backward feeding mixing screw length 44 mm (six screws) Total length: 264 mm (5.62 D)
Screw 3: Backward feeding mixing screw length 44 mm (two screws) Total length: 88 mm (1.87 D)

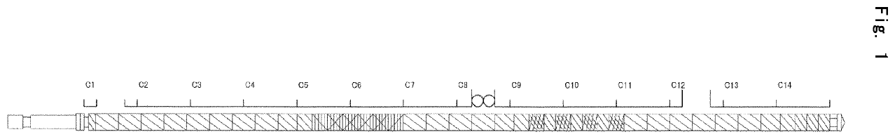

FIG. 1 is a conceptual diagram for explaining an example of a screw configuration of an extruder used in working examples and comparative examples.

A hopper is placed at position C1, and polybutylene terephthalate resin pellets listed in Table 2 below are supplied and transported by the R screw. The first kneading part is located at position C6 in the cylinder, and is constituted from any one of screws 1 to 4 listed in the table below. The pellets are kneaded by the first kneading part, and glass fibers are side-fed at a quantity of 30 mass % to the cylinder from position C8 and kneaded by the second kneading part constituted from any one of screws 1 to 3 listed in the table below, which are located at positions C9 to C11. Depressurization is then carried out using the vacuum vent located at position C12, and a strand is extruded from the die, cooled using a water bath, and cut into pellets using a pelletizer. The screw rotation speed, discharge rate and torque (percentage relative to a torque of 100%) are as shown in the tables, and a torque of 100% corresponds to a shaft torque density applied to one screw of 17.6 Nm/cm³. The shaft torque density at a screw shaft connecting part at the base of the extruder and the resin temperature of the strand immediately after being extruded are shown in the tables. Moreover, the shaft torque density applied to the screw shaft was determined by multiplying the measured torque (%) by the allowed screw torque (17.6 Nm/cm³).

The obtained pellets were molded into a type A test piece (170 mm×10 mm, thickness 4 mm) in accordance with ISO294-1 using an injection molding machine (J85AD produced by Japan Steel Works, Ltd).

Using the obtained test piece, the notched Charpy impact strength (units: KJ/m²) was measured in accordance with ISO179-1,2, and the tensile strength (units: MPa) was measured in accordance with ISO527.

Furthermore, in order to evaluate the degree of degradation of the polybutylene terephthalate resin, the intrinsic viscosity of the obtained polybutylene terephthalate resin pellets was measured using the method described below.

Intrinsic viscosity was measured using the method described above with an Ubbelohde type viscometer using a mixed solvent comprising phenol/tetrachloroethane at a ratio of 1/1. Moreover, the pellets containing glass fibers were dissolved in the mixed solvent and filtered to remove only the glass fibers, and the intrinsic viscosity was measured from the filtered solution.

### Working Example 1-1

Pellets were produced by using 35 mass % of PBT1A and 35 mass % of PBT2A (arithmetic mean intrinsic viscosity IV: 0.775 dl/g), and using screw 1 as the screw configuration of the first kneading part and screw 1 as the screw configuration of the second kneading part, with the screw rotation speed being 500 rpm and the discharge rate being 600 kg/h. Extrusion was stable and the strand did not break.

### Working Example 1-2

The same procedure as that used in Working Example 1-1 was carried out, except that screw 2 was used as the screw configuration of the first kneading part.

### Comparative Example 1-1

The same procedure as that used in Working Example 1-1 was carried out, except that screw 3 was used as the screw configuration of the first kneading part.

### Comparative Example 1-2

The same procedure as that used in Working Example 1-1 was carried out, except that screw 4 was used as the screw configuration of the first kneading part.

### Comparative Example 1-3

The same procedure as that used in Working Example 1-1 was carried out, except that the discharge rate was 400 kg/h.

### Comparative Example 1-4

The same procedure as that used in Working Example 1-2 was carried out, except that the discharge rate was 400 kg/h.

### Comparative Example 1-5

The same procedure as that used in Comparative Example 1-1 was carried out, except that the discharge rate was 400 kg/h.

### Comparative Example 1-6

The same procedure as that used in Comparative Example 1-2 was carried out, except that the discharge rate was 400 kg/h.

The results are shown in Tables 2-3 below.

TABLE 2

| PBT1A/PBT2A = | IV = | | | Comp. | Comp. |
|---|---|---|---|---|---|
| 35/35 | 0.775 | Ex. 1-1 | Ex. 1-2 | Ex. 1-1 | Ex. 1-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 70 | 75 | 85 | 65 |
| Shaft torque density | Nm/cm³ | 12.3 | 13.2 | 15.0 | 11.4 |
| Resin temperature | ° C. | 293 | 305 | 320 | 279 |
| Intrinsic viscosity | dl/g | 0.77 | 0.76 | 0.74 | 0.77 |
| Glass fiber length | μm | 847 | 841 | 843 | 792 |
| Charpy impact strength | kJ/m² | 10.0 | 10.1 | 8.9 | 8.8 |
| Tensile strength | MPa | 151 | 152 | 139 | 137 |

TABLE 3

| PBT1A/PBT2A = | IV = | Comp. | Comp. | Comp. | Comp. |
|---|---|---|---|---|---|
| 35/35 | 0.775 | Ex. 1-3 | Ex. 1-4 | Ex. 1-5 | Ex. 1-6 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 400 | 400 | 400 | 400 |
| Torque | % | 47 | 50 | 57 | 44 |
| Shaft torque density | Nm/cm³ | 8.3 | 8.8 | 10.0 | 7.7 |
| Resin temperature | ° C. | 302 | 315 | 329 | 292 |
| Intrinsic viscosity | dl/g | 0.76 | 0.74 | 0.72 | 0.77 |
| Glass fiber length | μm | 732 | 743 | 752 | 722 |
| Charpy impact strength | kJ/m² | 8.7 | 8.7 | 8.3 | 8.6 |
| Tensile strength | MPa | 137 | 138 | 135 | 139 |

### Working Examples 2-1 and 2-2 and Comparative Examples 2-1 and 2-2

The same procedure as that used in Working Examples 1-1 and 1-2 and Comparative Examples 1-1 and 1-2 was carried out, except that the amount of PBT1A was 56 mass %, the amount of PBT2A was 14 mass %, and the arithmetic mean intrinsic viscosity was 0.82 dl/g.

The results are shown in Table 4 below.

TABLE 4

| PBT1A/PBT2A = | IV = | | | Comp. | Comp. |
|---|---|---|---|---|---|
| 56/14 | 0.82 | Ex. 2-1 | Ex. 2-2 | Ex. 2-1 | Ex. 2-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 75 | 80 | 90 | 70 |
| Shaft torque density | Nm/cm³ | 13.2 | 14.1 | 15.8 | 12.3 |
| Resin temperature | ° C. | 302 | 309 | 325 | 282 |
| Intrinsic viscosity | dl/g | 0.8 | 0.78 | 0.72 | 0.81 |
| Glass fiber length | μm | 782 | 779 | 775 | 750 |
| Charpy impact strength | kJ/m² | 9.7 | 9.8 | 8.5 | 8.7 |
| Tensile strength | MPa | 145 | 146 | 136 | 137 |

### Working Examples 3-1 and 3-2 and Comparative Examples 3-1 and 3-2

The same procedure as that used in Working Examples 1-1 and 1-2 and Comparative Examples 1-1 and 1-2 was carried out, except that the amount of PBT1A was 14 mass %, the amount of PBT2A was 56 mass %, and the arithmetic mean intrinsic viscosity was 0.73 dl/g.

The results are shown in Table 5 below.

TABLE 5

| PBT1A/PBT2A = | IV = | | | Comp. | Comp. |
|---|---|---|---|---|---|
| 14/56 | 0.73 | Ex. 3-1 | Ex. 3-2 | Ex. 3-1 | Ex. 3-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 67 | 72 | 81 | 62 |
| Shaft torque density | Nm/cm³ | 11.8 | 12.7 | 14.3 | 10.9 |
| Resin temperature | ° C. | 290 | 301 | 315 | 277 |
| Intrinsic viscosity | dl/g | 0.72 | 0.71 | 0.66 | 0.72 |
| Glass fiber length | μm | 852 | 863 | 878 | 760 |
| Charpy impact strength | kJ/m² | 9.5 | 9.6 | 8.6 | 8.4 |
| Tensile strength | MPa | 146 | 145 | 138 | 131 |

### Working Examples 4-1 and 4-2 and Comparative Examples 4-1 and 4-2

The same procedure as that used in Working Examples 1-1 and 1-2 and Comparative Examples 1-1 and 1-2 was carried out, except that the amount of PBT1A was 70 mass %, and the intrinsic viscosity was 0.85 dl/g.

The results are shown in Table 6 below.

TABLE 6

| | IV = | | | Comp. | Comp. |
|---|---|---|---|---|---|
| PBT1A = 70 | 0.85 | Ex. 4-1 | Ex. 4-2 | Ex. 4-1 | Ex. 4-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 75 | 80 | 90 | 70 |
| Shaft torque density | Nm/cm³ | 13.2 | 14.1 | 15.8 | 12.3 |
| Resin temperature | ° C. | 307 | 311 | 329 | 286 |
| Intrinsic viscosity | dl/g | 0.83 | 0.82 | 0.75 | 0.84 |
| Glass fiber length | μm | 783 | 762 | 765 | 748 |
| Charpy impact strength | kJ/m² | 9.3 | 9.2 | 8.5 | 8.6 |
| Tensile strength | MPa | 143 | 142 | 135 | 138 |

### Working Examples 5-1 and 5-2 and Comparative Examples 5-1 and 5-2

The same procedure as that used in Working Examples 1-1 and 1-2 and Comparative Examples 1-1 and 1-2 was carried out, except that the amount of PBT2A was 70 mass %, and the intrinsic viscosity was 0.70 dl/g.

The results are shown in Table 7 below.

TABLE 7

| | IV = | | | Comp. | Comp. |
|---|---|---|---|---|---|
| PBT2A = 70 | 0.70 | Ex. 5-1 | Ex. 5-2 | Ex. 5-1 | Ex. 5-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 66 | 70 | 80 | 60 |
| Shaft torque density | Nm/cm³ | 11.6 | 12.3 | 14.1 | 10.6 |
| Resin temperature | ° C. | 288 | 298 | 313 | 274 |
| Intrinsic viscosity | dl/g | 0.69 | 0.68 | 0.65 | 0.7 |
| Glass fiber length | μm | 862 | 872 | 865 | 742 |
| Charpy impact strength | kJ/m² | 9.1 | 9.4 | 8.6 | 8.2 |
| Tensile strength | MPa | 140 | 142 | 137 | 130 |

### Working Example 1-3

The same procedure as that used in Working Example 1-1 was carried out, except that screw 2 was used as the screw configuration of the second kneading part.

### Working Example 1-4

The same procedure as that used in Working Example 1-1 was carried out, except that screw 3 was used as the screw configuration of the second kneading part. In this case, the strand was cut once every 2 minutes, and it was understood that slight problems occurred in terms of productivity. The screw configuration was weak, and it is possible that the openability of the glass fibers was insufficient.

The results are shown in Table 8 below.

TABLE 8

| PBT1A/PBT2A = | IV = | | |
|---|---|---|---|
| 35/35 | 0.775 | Ex. 1-3 | Ex. 1-4 |
| First kneading part | | Screw 1 | Screw 1 |
| | Length | 5.62 D | 5.62 D |
| Second kneading part | | Screw 2 | Screw 3 |
| | Length | 5.62 D | 1.87 D |
| Screw rotation speed | rpm | 500 | 500 |
| Discharge rate | kg/h | 600 | 600 |
| Torque | % | 70 | 75 |
| Shaft torque density | Nm/cm³ | 13.2 | 13.2 |
| Resin temperature | ° C. | 309 | 290 |
| Intrinsic viscosity | dl/g | 0.737 | 0.77 |
| Glass fiber length | μm | 721 | 932 |
| Charpy impact strength | kJ/m² | 9.1 | 10.2 |
| Tensile strength | MPa | 142 | 155 |

### Working Examples 6-1 and 6-2, Comparative Example 6-1 and Comparative Example 6-2

The same procedure as that used in Working Examples 1-1 and 1-2 and Comparative Example 1-1 and Comparative Example 1-2 was carried out, except that the amount of PBT1A was 30 mass %, the amount of PBT2A was 30 mass %, the arithmetic mean intrinsic viscosity was 0.775 dl/g and 10 mass % of an AS resin was also added.

The results are shown in Table 9 below.

TABLE 9

| | PBT | | | | |
|---|---|---|---|---|---|
| PBT1A/PBT2A = | IV = | | | Comp. | Comp. |
| 30/30 + AS 10% | 0.775 | Ex. 6-1 | Ex. 6-2 | Ex. 6-1 | Ex. 6-2 |
| First kneading part | | Screw 1 | Screw 2 | Screw 3 | Screw 4 |
| | Length | 5.62 D | 7.48 D | 9.36 D | 4.68 D |
| Second kneading part | | Screw 1 | Screw 1 | Screw 1 | Screw 1 |
| | Length | 3.74 D | 3.74 D | 3.74 D | 3.74 D |
| Screw rotation speed | rpm | 500 | 500 | 500 | 500 |
| Discharge rate | kg/h | 600 | 600 | 600 | 600 |
| Torque | % | 70 | 75 | 85 | 65 |
| Shaft torque density | Nm/cm³ | 12.3 | 13.2 | 15.0 | 11.4 |
| Resin temperature | ° C. | 290 | 302 | 318 | 276 |
| Intrinsic viscosity | dl/g | 0.77 | 0.76 | 0.74 | 0.77 |
| Glass fiber length | μm | 853 | 855 | 860 | 799 |
| Charpy impact strength | kJ/m² | 10.6 | 10.5 | 8.7 | 8.6 |
| Tensile strength | MPa | 156 | 155 | 138 | 137 |

### Comparative Example 7-1

The same procedure as that used in Working Example 1-1 was carried out, except that PBT1A used in Working Example 1-1 was replaced by PBT1B and PBT2A was replaced by PBT2B.

### Comparative Example 7-2

The same procedure as that used in Working Example 1-1 was carried out, except that PBT1A used in Working Example 1-1 was replaced by PBT1C and PBT2A was replaced by PBT2C.

The results are shown in Table 10 below.

TABLE 10

| | | | PBT1B/ | PBT1C/ |
|---|---|---|---|---|
| | | PBT1A/ | PBT2B | PBT2C |
| PBT1/PBT2 = | IV = | PBT2A | Comp. | Comp. |
| 35/35 | 0.775 | Ex. 1-1 | Ex. 7-1 | Ex. 7-2 |
| First kneading part | | Screw 1 | Screw 1 | Screw 1 |
| | Length | 5.62 D | 5.62 D | 5.62 D |
| Second kneading part | | Screw 1 | Screw 1 | Screw 1 |
| | Length | 3.74 D | 3.74 D | 3.74 D |
| Screw rotation speed | rpm | 500 | 500 | 500 |
| Discharge rate | kg/h | 600 | 600 | 600 |
| Torque | % | 70 | 73 | 71 |
| Shaft torque density | Nm/cm³ | 12.3 | 12.8 | 12.5 |
| Resin temperature | ° C. | 293 | 312 | 281 |
| Intrinsic viscosity | dl/g | 0.77 | 0.74 | 0.77 |
| Glass fiber length | μm | 847 | 853 | 781 |
| Charpy impact strength | kJ/m² | 10.0 | 8.8 | 8.7 |
| Tensile strength | MPa | 151 | 138 | 139 |

### Comparative Example 8-1

The same procedure as that used in Working Example 1-2 was carried out, except that PBT1A used in Working Example 1-2 was replaced by PBT1B and PBT2A was replaced by PBT2B.

### Comparative Example 8-2

The same procedure as that used in Working Example 1-2 was carried out, except that PBT1A used in Working Example 1-2 was replaced by PBT1C and PBT2A was replaced by PBT2C.

The results are shown in Table 11 below.

TABLE 11

| | | | PBT1B/ | PBT1C/ |
|---|---|---|---|---|
| | | PBT1A/ | PBT2B | PBT2C |
| PBT1/PBT2 = | IV = | PBT2A | Comp. | Comp. |
| 35/35 | 0.775 | Ex. 1-2 | Ex. 8-1 | Ex. 8-2 |
| First kneading part | | Screw 2 | Screw 2 | Screw 2 |
| | Length | 7.48 D | 7.48 D | 7.48 D |
| Second kneading part | | Screw 1 | Screw 1 | Screw 1 |
| | Length | 3.74 D | 3.74 D | 3.74 D |
| Screw rotation speed | rpm | 500 | 500 | 500 |
| Discharge rate | kg/h | 600 | 600 | 600 |
| Torque | % | 75 | 78 | 72 |
| Shaft torque density | Nm/cm³ | 13.2 | 13.7 | 12.7 |
| Resin temperature | ° C. | 305 | 316 | 282 |
| Intrinsic viscosity | dl/g | 0.76 | 0.72 | 0.77 |
| Glass fiber length | μm | 841 | 848 | 770 |
| Charpy impact strength | kJ/m² | 10.1 | 8.9 | 8.8 |
| Tensile strength | MPa | 152 | 132 | 138 |

### Comparative Example 9-1

The same procedure as that used in Working Example 2-2 was carried out, except that PBT1A used in Working Example 2-2 was replaced by PBT1B and PBT2A was replaced by PBT2B.

### Comparative Example 9-2

The same procedure as that used in Working Example 2-2 was carried out, except that PBT1A used in Working Example 2-2 was replaced by PBT1C and PBT2A was replaced by PBT2C.

The results are shown in Table 12 below.

TABLE 12

| | | | PBT1B/ | PBT1C/ |
|---|---|---|---|---|
| | | PBT1A/ | PBT2B | PBT2C |
| PBT1/PBT2 = | IV = | PBT2A | Comp. | Comp. |
| 56/14 | 0.82 | Ex. 2-2 | Ex. 9-1 | Ex. 9-2 |
| First kneading part | | Screw 2 | Screw 2 | Screw 2 |
| | Length | 7.48 D | 7.48 D | 7.48 D |
| Second kneading part | | Screw 1 | Screw 1 | Screw 1 |
| | Length | 3.74 D | 3.74 D | 3.74 D |
| Screw rotation speed | rpm | 500 | 500 | 500 |
| Discharge rate | kg/h | 600 | 600 | 600 |
| Torque | % | 80 | 82 | 76 |
| Shaft torque density | Nm/cm³ | 14.1 | 14.5 | 13.3 |
| Resin temperature | ° C. | 309 | 324 | 288 |
| Intrinsic viscosity | dl/g | 0.78 | 0.76 | 0.80 |
| Glass fiber length | μm | 779 | 820 | 775 |
| Charpy impact strength | kJ/m² | 9.8 | 8.8 | 8.8 |
| Tensile strength | MPa | 146 | 133 | 137 |

### Comparative Example 10-1

The same procedure as that used in Working Example 3-2 was carried out, except that PBT1A used in Working Example 3-2 was replaced by PBT1B and PBT2A was replaced by PBT2B.

### Comparative Example 10-2

The same procedure as that used in Working Example 3-2 was carried out, except that PBT1A used in Working Example 3-2 was replaced by PBT1C and PBT2A was replaced by PBT2C.

The results are shown in Table 13 below.

TABLE 13

| | | | PBT1B/ | PBT1C/ |
|---|---|---|---|---|
| | | PBT1A/ | PBT2B | PBT2C |
| PBT1/PBT2 = | IV = | PBT2A | Comp. | Comp. |
| 14/56 | 0.73 | Ex. 3-2 | Ex. 10-1 | Ex. 10-2 |
| First kneading part | | Screw 2 | Screw 2 | Screw 2 |
| | Length | 7.48 D | 7.48 D | 7.48 D |
| Second kneading part | | Screw 1 | Screw 1 | Screw 1 |
| | Length | 3.74 D | 3.74 D | 3.74 D |
| Screw rotation speed | rpm | 500 | 500 | 500 |
| Discharge rate | kg/h | 600 | 600 | 600 |
| Torque | % | 72 | 75 | 71 |
| Shaft torque density | Nm/cm³ | 12.7 | 13.2 | 12.5 |
| Resin temperature | ° C. | 301 | 315 | 280 |
| Intrinsic viscosity | dl/g | 0.71 | 0.69 | 0.73 |
| Glass fiber length | μm | 863 | 882 | 790 |
| Charpy impact strength | kJ/m² | 9.6 | 8.7 | 8.6 |
| Tensile strength | MPa | 145 | 135 | 137 |

### Comparative Example 11-1

The same procedure as that used in Working Example 6-2 was carried out, except that PBT1A used in Working Example 6-2 was replaced by PBT1B and PBT2A was replaced by PBT2B.

### Comparative Example 11-2

The same procedure as that used in Working Example 6-2 was carried out, except that PBT1A used in Working Example 6-2 was replaced by PBT1C and PBT2A was replaced by PBT2C.

The results are shown in Table 14 below.

TABLE 14

| | | | PBT1B/ | PBT1C/ |
|---|---|---|---|---|
| | PBT | PBT1A/ | PBT2B | PBT2C |
| PBT1/PBT2 = | IV = | PBT2A | Comp. | Comp. |
| 30/30 + AS 10% | 0.775 | Ex. 6-2 | Ex. 11-1 | Ex. 11-2 |
| First kneading part | | Screw 2 | Screw 2 | Screw 2 |
| | Length | 7.48 D | 7.48 D | 7.48 D |
| Second kneading part | | Screw 1 | Screw 1 | Screw 1 |
| | Length | 3.74 D | 3.74 D | 3.74 D |
| Screw rotation speed | rpm | 500 | 500 | 500 |
| Discharge rate | kg/h | 600 | 600 | 600 |
| Torque | % | 75 | 78 | 72 |
| Shaft torque density | Nm/cm³ | 13.2 | 13.6 | 12.7 |
| Resin temperature | ° C. | 302 | 314 | 281 |
| Intrinsic viscosity | dl/g | 0.76 | 0.73 | 0.77 |
| Glass fiber length | μm | 855 | 872 | 803 |
| Charpy impact strength | kJ/m² | 10.5 | 8.9 | 8.8 |
| Tensile strength | MPa | 155 | 139 | 138 |

### INDUSTRIAL APPLICABILITY

According to the production method of the present invention, a fiber-reinforced polybutylene terephthalate resin composition having excellent mechanical strength can be produced with high productivity, and a molded article comprising said composition can adequately achieve the required performance in terms of reduced weight, reduced thickness and strength, and can be used in a wide variety of applications, such as components of motor vehicles, electrical/electronic equipment and precision instruments.

1. A method for producing a fiber-reinforced polybutylene terephthalate resin composition comprising (A) 40 to 90 mass % of a polybutylene terephthalate resin, (B) 10 to 60 mass % of reinforcing fibers, and (C) 0 to 35 mass % of other polymers or additives, each based on 100 mass % of a total amount of (A), (B), and (C), by using a twin-screw extruder, wherein the twin-screw extruder comprises a first kneading part, a second kneading part, and a vent,
the method comprising:
using polybutylene terephthalate resin pellets having an average weight of 16 mg or more and 29 mg or less as a raw material for the polybutylene terephthalate resin (A),
kneading the polybutylene terephthalate resin (A) and the other polymers or additives (C) with the first kneading part,
adding the reinforcing fibers (B) at a part downstream of the first kneading part and performing kneading with the second kneading part, and then
reducing a pressure of the vent at a part downstream of the second kneading part and performing a devolatilization,
wherein
the first kneading part has a configuration in which a length thereof is 5.0 D to 9.0 D, wherein D is a cylinder diameter and which is obtained by combining two or more of an R kneading disc, an N kneading disc, an L kneading disc, an L screw, a sealing ring, a mixing screw and a rotor screw, and
the second kneading part has a configuration which is obtained by combining one or more of an R kneading disc, an N kneading disc, 2 an L kneading disc, an L screw, a sealing ring and a mixing screw, and
production is carried out under a screw shaft torque density of 11.5 to 19 Nm/cm³.

2. The method of claim 1, wherein the other polymers or additives (C) comprise a styrenic polymer at a quantity of 5 to 30 mass % relative to the total of 100 mass % of the polybutylene terephthalate resin (A), the reinforcing fibers (B), and the other polymers or additives (C).

3. The production method of claim 1, wherein a temperature of a resin strand is 290 to 310° C. immediately after being extruded in the reducing of the pressure of the vent at the part downstream of the second kneading part and performing the devolatilization.

4. The method of claim 1, wherein an intrinsic viscosity of the polybutylene terephthalate resin (A) is 0.72 to 0.83 dl/g.

5. The method of claim 1, wherein a total length of the second kneading part is 2.5 D or more and 5.0 D or less.

6. The method of claim 1, wherein a notched Charpy impact strength of an obtained resin composition, as measured in accordance with ISO179-1,2, is 9 kJ/m² or more.

7. The method of claim 1, wherein a tensile strength of an obtained resin composition, as measured in accordance with ISO527, is 140 MPa or more.

8. The method of claim 1, wherein the screw shaft torque density is 13 to 19 Nm/cm³.
